(19) United States
(12) Patent Application Publication
(10) Pub. No.: US 2021/0406933 A1
(43) Pub. Date: Dec. 30, 2021

(54) ARTIFICIAL INTELLIGENCE FOR NEXT BEST ACTION

(71) Applicant: 6SENSE INSIGHTS, INC., San Francisco, CA (US)

(72) Inventors: Dan CARMODY, Berkeley, CA (US); Swetha KRISHNAKUMAR, Santa Clara, CA (US); Kenneth GOLONKA, San Francisco, CA (US); Sara AKHAVI, Los Altos, CA (US); Amar DOSHI, Sunnyvale, CA (US); Premal SHAH, Union City, CA (US); Viral BAJARIA, San Francisco, CA (US); Steven SASSAMAN, San Francisco, CA (US)

(21) Appl. No.: 17/362,605

(22) Filed: Jun. 29, 2021

Related U.S. Application Data
(60) Provisional application No. 63/045,731, filed on Jun. 29, 2020.

(51) Int. Cl. G06Q 30/02; G06N 20/20; G06N 5/00; G06N 5/04; G06Q 30/00; G06Q 10/10; H04L 29/08

(52) U.S. Cl. CPC G06Q 30/0202; G06N 20/20; G06N 5/003; H04L 67/22; G06Q 30/0201; G06Q 30/016; G06Q 10/105; G06N 5/04

(57) ABSTRACT

Artificial intelligence for next best action. In an embodiment, contact data and contact-specific activity data are received from a user system. A profile model is applied to the contact data to generate a profile score for each contact, and an intent model is applied to the contact-specific activity data to generate an intent score for each contact. Contact recommendations are determined based on the profile scores and the intent scores, and a recommended contact list is generated based on the contact recommendations. The recommended contact list may then be provided to a user.

### CROSS-REFERENCE TO RELATED APPLICATIONS

This application claims priority to U.S. Provisional Patent App. No. 63/045,731, filed on Jun. 29, 2020, which is hereby incorporated herein by reference as if set forth in full.

This application is also related to U.S. Pat. No. 9,202,227 (“the '227 patent”), issued on Dec. 1, 2015, U.S. Pat. No. 10,475,056 (“the '056 patent”), issued on Nov. 12, 2019, and U.S. Pat. No. 10,536,427 (“the '427 patent”), issued on Jan. 14, 2020, which are all hereby incorporated herein by reference as if set forth in full. This application is also related to U.S. Provisional Patent App. No. 63/045,693, filed on Jun. 29, 2020, and U.S. Provisional Patent App. No. 63/045,707, filed on Jun. 29, 2020, which are both hereby incorporated herein by reference as if set forth in full.

### BACKGROUND

### Field of the Invention

The embodiments described herein are generally directed to artificial intelligence (AI), and, more particularly, to AI models for determining a next best action.

### Description of the Related Art

Sales intelligence refers to technologies that collect, integrate, analyze, and present information to help sales representatives find, monitor, and understand data that provides insights into the business of existing and prospective buyers. It would be helpful if aspects of sales intelligence, such as determining the next best action(s) to take with respect to sales opportunities, could be automated. However, present sales intelligence applications do not provide intelligence that is sufficient to automate such tasks.

### SUMMARY

Thus, systems, methods, and non-transitory computer-readable media are disclosed for artificial intelligence that is capable of automatically determining a next best action. For instance, disclosed embodiments overcome obstacles to automation, in order to imbue a computer with artificial intelligence that is sufficient to automatically determine the next best action(s) to take with respect to sales opportunities.

In an embodiment, a method comprises using at least one hardware processor to: receive contact data from a user system, wherein the contact data comprise contact information for each of a plurality of contacts; apply a profile model to the contact data to generate a profile score for each of the plurality of contacts; receive contact-specific activity data from the user system, wherein the contact-specific activity data comprise activity information for each of the plurality of contacts; apply an intent model to the contact-specific activity data to generate an intent score for each of the plurality of contacts; determine one or more contact recommendations based on the profile scores and the intent scores for the plurality of contacts; generate a recommended contact list comprising a contact entry for each of the one or more contact recommendations; and provide the recommended contact list to at least one user.

The profile model may comprise a machine-learning algorithm that, for each of the plurality of contacts, predicts a likelihood of a positive sales opportunity based on one or more features of the contact. The one or more features may comprise a job level and job function. The machine-learning algorithm may be trained on a training dataset comprising the one or more features associated with one or both of positive sales opportunities and negative sales opportunities. The machine-learning algorithm may comprise a random forest algorithm. The machine-learning algorithm may comprise a gradient-boosting algorithm. The method may further comprise using the at least one hardware processor to retrieve the profile model from a plurality of profile models based on a customer account associated with the at least one user, wherein each of the plurality of profile models is associated with a different customer account.

The intent model may comprise a statistical model based on a naïve Bayes algorithm. For each of the plurality of contacts, the activity information may comprise representations of online activities associated with that contact, wherein the statistical model weights the representations of online activities to generate the intent score for the contact. The online activities may comprise one or more of a visit to a website, opening an electronic document, opening an email message, sending an email message, or submitting a web form. The statistical model may comprise one or more time-decay factors to weight representations of more recent online activities greater than representations of less recent online activities.

The method may further comprise using the at least one hardware processor to: receive company-specific activity data from one or more data sources, wherein the company-specific activity data comprise activity information for each of a plurality of companies; apply another intent model to the company-specific activity data to generate an intent score for each of the plurality of companies; retrieve a plurality of people records from a master people database, wherein the plurality of people records comprise contact information for a plurality of people; apply a persona model to the plurality of people records to generate a persona score for each of the plurality of people; and determine one or more prospective contact recommendations based on the persona scores for the plurality of people, wherein the recommended contact list further comprises a contact entry for each of the one or more prospective contact recommendations. Applying the persona model to the plurality of people records to generate a persona score for each of the plurality of people may comprise, for each of the plurality of people records: determining an average profile score for a subset of the plurality of contacts that have a job level and job function that matches a job level and job function derived from the people record; and determining the persona score based on the average profile score. Determining one or more prospective contact recommendations may comprise excluding any of the plurality of people that are represented in the contact data. Each contact entry for the one or more contact recommendations may comprise identifying information, wherein each contact entry for the one or more prospective contact recommendations does not comprise identifying information. Providing the recommended contact list to at least one user may comprise incorporating the recommended contact list into a graphical user interface, wherein each contact entry for the one or more prospective contact recommendations comprises an input for acquiring the identifying information. The method may further comprise using the at least one hardware processor to, in response to selection of the input in a contact entry for one of the one or more prospective contact recommendations, interface with an external system via an application programming interface (API) of the external system to: generate a contact object in the external system; and populate the contact object in the external system with information from one of the plurality of people records corresponding to the contact entry for which the input was selected.

Determining one or more contact recommendations may comprise excluding any of the plurality of contacts for which the contact data comprise a representation of an outreach within a predefined past time window from a current time.

The method may further comprise using the at least one hardware processor to generate one or more talking points for each of one or more of the plurality of contacts. Providing the recommended contact list to at least one user may comprise incorporating the recommended contact list into a graphical user interface, wherein each contact entry for each of the one or more contact recommendations comprises an input for viewing the one or more talking points. Generating the one or more talking points may comprise: receiving company-specific activity data from one or more data sources, wherein the company-specific activity data comprise activity information for each of a plurality of companies; identifying one or more keywords, representing one or more brand names, in the company-specific activity data; and, based on the identification, generating a talking point that prompts the at least one user to highlight a competitive differentiation with respect to the one or more brand names. Generating the one or more talking points may comprise: receiving company-specific activity data from one or more data sources, wherein the company-specific activity data comprise activity information for each of a plurality of companies; identifying one or more keywords, associated with a product that is associated with a customer account of the at least one user but not associated with a brand name associated with the customer account, in the company-specific activity data associated with at least one of the plurality of companies; and, based on the identification, generating a talking point that prompts the at least one user to contact the at least one company. Generating the one or more talking points may comprise: identifying at least one of the plurality of contacts associated with an intent score above a predefined threshold and satisfying one or more other criteria; and, based on the identification, generating a talking point that prompts the at least one user to contact the at least one contact.

Providing the recommended contact list to at least one user may comprise incorporating the recommended contact list into a graphical user interface, wherein each contact entry for each of the one or more contact recommendations comprises an input for initiating a communication with a contact represented by that contact entry, and wherein the method further comprises using the at least one hardware processor to, in response to selection of the input in one of the contact entries by the at least one user, interface with an external system via an application programming interface (API) of the external system, to: authenticate with the external system using an API key associated with a customer account associated with the at least one user; and generate a communication object, associated with the contact represented by the one contact entry, in the external system.

Providing the recommended contact list to at least one user may comprise incorporating the recommended contact list into a graphical user interface, wherein each contact entry for each of the one or more contact recommendations comprises an input for retrieving information, associated with a contact represented by that contact entry, from an external system, and wherein the method further comprises using the at least one hardware processor to, in response to selection of the input in one of the contact entries by the at least one user: interface with the external system via an application programming interface (API) of the external system, to authenticate with the external system using an API key associated with a customer account associated with the at least one user, and acquire the information, associated with the contact represented by the one contact entry, from the external system; and incorporate the acquired information into the graphical user interface.

The disclosed methods may be embodied in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein, may be implemented, according to an embodiment;

FIG. 2 illustrates an example processing system, by which one or more of the processes described herein, may be executed, according to an embodiment;

FIG. 3 illustrates an example contact recommendation engine, according to an embodiment;

FIG. 4 illustrates an example flowchart of possible user interactions with a next-best-actions AI, according to an embodiment; and

FIGS. 5A and 5B illustrate examples of graphical user interfaces that provide access to aspects of a next-best-actions AI, according to an embodiment.

### DETAILED DESCRIPTION

In an embodiment, systems, methods, and non-transitory computer-readable media are disclosed for artificial intelligence that determines a next best action (NBA). For example, an AI model may use data, collected and processed for an account or contact, to suggest (e.g., to a business-to-business sales team) next action(s) that a sales representative can take to help engage an account to open a new sales opportunity and/or progress a pending sales opportunity, including the generation of talking points to be used when communicating with a contact.

After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. System Overview

### 1.1. Infrastructure

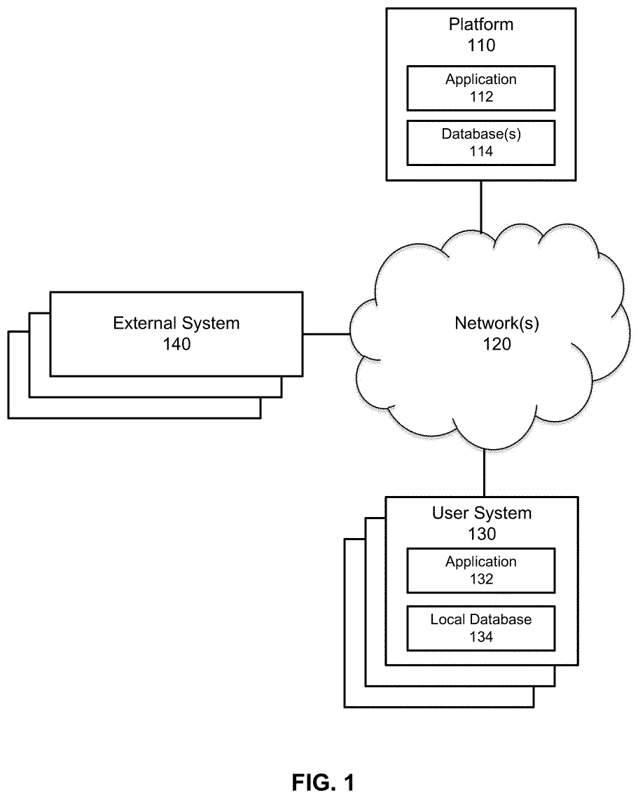

FIG. 1 illustrates an example infrastructure in which the disclosed processes may operate, according to an embodiment. The infrastructure may comprise a platform 110 (e.g., one or more servers) which hosts and/or executes one or more of the various functions, processes, methods, and/or software modules described herein, such as the disclosed sales intelligence application or NBA artificial intelligence. Platform 110 may comprise dedicated servers, or may instead comprise cloud instances, which utilize shared resources of one or more servers. These servers or cloud instances may be collocated and/or geographically distributed. Platform 110 may also comprise or be communicatively connected to a server application 112 and/or one or more databases 114. In addition, platform 110 may be communicatively connected to one or more user systems 130 via one or more networks 120. Platform 110 may also be communicatively connected to one or more external systems 140 (e.g., other platforms, websites, etc.) via one or more networks 120.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one set of database(s) 114 are illustrated, it should be understood that the infrastructure may comprise any number of user systems, external systems, server applications, and databases.

User system(s) 130 may comprise any type or types of computing devices capable of wired and/or wireless communication, including without limitation, desktop computers, laptop computers, tablet computers, smart phones or other mobile phones, servers, televisions, set-top boxes, electronic kiosks, point-of-sale terminals, and/or the like. However, user system(s) 130 are primarily contemplated to comprise a workstation, personal computer, and/or mobile device from which marketing or sales employees of a customer of platform 100 can access the disclosed application. Thus, it should be understood that, while the terms “user” and “customer” may be used interchangeably herein, the term “customer” refers to the entire business enterprise that is attempting to market or sell a product, whereas the term “user” refers to an agent (e.g., marketing or sales representative) or team (e.g., marketing or sales team) of that business enterprise responsible for marketing or selling the product.

External system(s) 140 may also comprise any type or types of computing devices capable of wired and/or wireless communication. However, external system(s) 140 are primarily contemplated to be other servers (e.g., similar to server application 112) or platforms (e.g., similar to platform 110) that provide related third-party services. Examples of external system(s) 140 comprise the Salesforce™ platform provided by Salesforce.com, Inc. of San Francisco, Calif., the Marketo™ platform provided by Marketo, Inc. of San Mateo, Calif., the SalesLoft™ platform provided by SalesLoft of Atlanta, Ga., and the Sales Navigator™ and LinkedIn™ platforms provided by LinkedIn of Sunnyvale, Calif.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 114) that are locally and/or remotely accessible to platform 110. Platform 110 may also respond to other requests from user system(s) 130.

Platform 110 may further comprise, be communicatively coupled with, or otherwise have access to one or more database(s) 114. For example, platform 110 may comprise one or more database servers which manage one or more databases 114. A user system 130 or server application 112 executing on platform 110 may submit data (e.g., user data, form data, etc.) to be stored in database(s) 114, and/or request access to data stored in database(s) 114. Any suitable database may be utilized, including without limitation MySQL™, Oracle™, IBM™, Microsoft SQL™, Access™, PostgreSQL™, and the like, including cloud-based databases and proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., comprised in server application 112), executed by platform 110.

In embodiments in which a web service is provided, platform 110 may receive requests from external system(s) 140, and provide responses in eXtensible Markup Language (XML), JavaScript Object Notation (JSON), and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes, methods, functionality, storage, and/or the like, described herein. For example, in such an embodiment, a client application 132 (e.g., with access to a local database 134) executing on one or more user system(s) 130 may interact with a server application 112 executing on platform 110 to execute one or more or a portion of one or more of the various functions, processes, methods, and/or software modules described herein. Client application 132 may be “thin,” in which case processing is primarily carried out server-side by server application 112 on platform 110. A basic example of a thin client application is a browser application, which simply requests, receives, and renders webpages at user system(s) 130, while the server application on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the application described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules that implement one or more of the functions, processes, or methods of the application described herein.

### 1.2. Example Processing Device

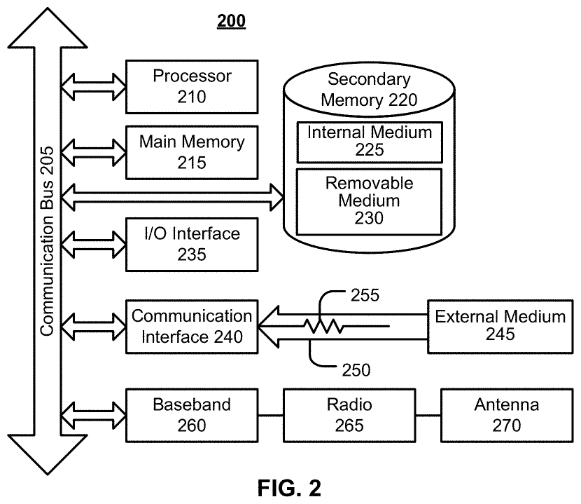

FIG. 2 is a block diagram illustrating an example wired or wireless system 200 that may be used in connection with various embodiments described herein. For example, system 200 may be used as or in conjunction with one or more of the functions, processes, or methods (e.g., to store and/or execute the application or one or more software modules of the application) described herein, and may represent components of platform 110, user system(s) 130, external system(s) 140, and/or other processing devices described herein. System 200 can be a server or any conventional personal computer, or any other processor-enabled device that is capable of wired or wireless data communication. Other computer systems and/or architectures may be also used, as will be clear to those skilled in the art.

System 200 preferably includes one or more processors, such as processor 210. Additional processors may be provided, such as an auxiliary processor to manage input/output, an auxiliary processor to perform floating-point mathematical operations, a special-purpose microprocessor having an architecture suitable for fast execution of signal-processing algorithms (e.g., digital-signal processor), a slave processor subordinate to the main processing system (e.g., back-end processor), an additional microprocessor or controller for dual or multiple processor systems, and/or a coprocessor. Such auxiliary processors may be discrete processors or may be integrated with processor 210. Examples of processors which may be used with system 200 include, without limitation, the Pentium® processor, Core i7® processor, and Xeon® processor, all of which are available from Intel Corporation of Santa Clara, Calif.

Processor 210 is preferably connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPM), IEEE 696/S-100, and/or the like.

System 200 preferably includes a main memory 215 and may also include a secondary memory 220. Main memory 215 provides storage of instructions and data for programs executing on processor 210, such as one or more of the functions and/or modules discussed herein. It should be understood that programs stored in the memory and executed by processor 210 may be written and/or compiled according to any suitable language, including without limitation C/C++, Java, JavaScript, Perl, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 220 may optionally include an internal medium 225 and/or a removable medium 230. Removable medium 230 is read from and/or written to in any well-known manner. Removable storage medium 230 may be, for example, a magnetic tape drive, a compact disc (CD) drive, a digital versatile disc (DVD) drive, other optical drive, a flash memory drive, and/or the like.

Secondary memory 220 is a non-transitory computer-readable medium having computer-executable code (e.g., disclosed software modules) and/or other data stored thereon. The computer software or data stored on secondary memory 220 is read into main memory 215 for execution by processor 210.

In alternative embodiments, secondary memory 220 may include other similar means for allowing computer programs or other data or instructions to be loaded into system 200. Such means may include, for example, a communication interface 240, which allows software and data to be transferred from external storage medium 245 to system 200. Examples of external storage medium 245 may include an external hard disk drive, an external optical drive, an external magneto-optical drive, and/or the like. Other examples of secondary memory 220 may include semiconductor-based memory, such as programmable read-only memory (PROM), erasable programmable read-only memory (EPROM), electrically erasable read-only memory (EEPROM), and flash memory (block-oriented memory similar to EEPROM).

As mentioned above, system 200 may include a communication interface 240. Communication interface 240 allows software and data to be transferred between system 200 and external devices (e.g. printers), networks, or other information sources. For example, computer software or executable code may be transferred to system 200 from a network server (e.g., platform 110) via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 240 are generally in the form of electrical communication signals 255. These signals 255 may be provided to communication interface 240 via a communication channel 250. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (e.g., computer programs, such as the disclosed application, or software modules) is stored in main memory 215 and/or secondary memory 220. Computer programs can also be received via communication interface 240 and stored in main memory 215 and/or secondary memory 220. Such computer programs, when executed, enable system 200 to perform the various functions of the disclosed embodiments as described elsewhere herein.

In this description, the term “computer-readable medium” is used to refer to any non-transitory computer-readable storage media used to provide computer-executable code and/or other data to or within system 200. Examples of such media include main memory 215, secondary memory 220 (including internal memory 225, removable medium 230, and external storage medium 245), and any peripheral device communicatively coupled with communication interface 240 (including a network information server or other network device). These non-transitory computer-readable media are means for providing executable code, programming instructions, software, and/or other data to system 200.

In an embodiment that is implemented using software, the software may be stored on a computer-readable medium and loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform one or more of the processes and functions described elsewhere herein.

In an embodiment, I/O interface 235 provides an interface between one or more components of system 200 and one or more input and/or output devices. Example input devices include, without limitation, sensors, keyboards, touch screens or other touch-sensitive devices, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet, or other mobile device).

System 200 may also include optional wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is also communicatively coupled with processor 210, which may be a central processing unit (CPU). Processor 210 has access to data storage areas 215 and 220. Processor 210 is preferably configured to execute instructions (i.e., computer programs, such as the disclosed application, or software modules) that can be stored in main memory 215 or secondary memory 220. Computer programs can also be received from baseband processor 260 and stored in main memory 210 or in secondary memory 220, or executed upon receipt. Such computer programs, when executed, enable system 200 to perform the various functions of the disclosed embodiments.

### 2. Process Overview

Embodiments of processes for artificial intelligence that determines a next best action will now be described in detail. It should be understood that the described processes may be embodied in one or more software modules that are executed by one or more hardware processors (e.g., processor 210), e.g., as the application discussed herein (e.g., server application 112, client application 132, and/or a distributed application comprising both server application 112 and client application 132), which may be executed wholly by processor(s) of platform 110, wholly by processor(s) of user system(s) 130, or may be distributed across platform 110 and user system(s) 130, such that some portions or modules of the application are executed by platform 110 and other portions or modules of the application are executed by user system(s) 130. The described processes may be implemented as instructions represented in source code, object code, and/or machine code. These instructions may be executed directly by the hardware processor(s), or alternatively, may be executed by a virtual machine operating between the object code and the hardware processors. In addition, the disclosed application may be built upon or interfaced with one or more existing systems.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

Furthermore, while the processes, described herein, are illustrated with a certain arrangement and ordering of steps, each process may be implemented with fewer, more, or different steps and a different arrangement and/or ordering of steps. In addition, it should be understood that any step, which does not depend on the completion of another step, may be executed before, after, or in parallel with that other independent step, even if the steps are described or illustrated in a particular order.

In an embodiment, the application supported by platform 110 comprises a sales intelligence application. Customers of platform 110 may utilize the functions of the sales intelligence application via one or more user accounts with the sales intelligence application. A user may be a member of a marketing or sales team of an enterprise customer that logs in to a user account with the sales intelligence application to derive intelligence for business-to-business (B2B) sales of one or more goods or services (collectively referred to herein as “products”), sold by the enterprise customer, to other companies. These other companies may be represented as company accounts in the customer's system, which may include a customer relationship management (CRM) system, marketing automation platform (MAP) system, and/or the like. It should be understood that each customer's system may be an external system 140 with respect to platform 110, but may either be internal to the customer (e.g., an inhouse system) or external to the customer (e.g., a third-party system with which the customer has an account).

In an embodiment, the sales intelligence application comprises an artificial intelligence that determines next best actions to take with respect to potential and/or existing sales opportunities. This NBA function may be implemented as an AI-driven layer, within the sales intelligence application, that can automatically generate contact recommendations, talking points, and/or other insights. Advantageously, the NBA artificial intelligence overcomes obstacles to automation to eliminate or reduce guesswork for users (e.g., marketing or sales representatives) by providing time-based recommendations for appropriate contact outreach, messaging, and/or the like. In some cases, the NBA artificial intelligence may construct and/or update a pipeline of recommended actions for customers to follow for one or more company accounts.

### 2.1. Contact Recommendation

In an embodiment, the NBA artificial intelligence automatically generates contact recommendations for users. These contact recommendations represent recommended outreach actions related to specific contacts. In other words, a contact recommendation can be considered a recommended next best action that comprises initiating a communication with a particular contact.

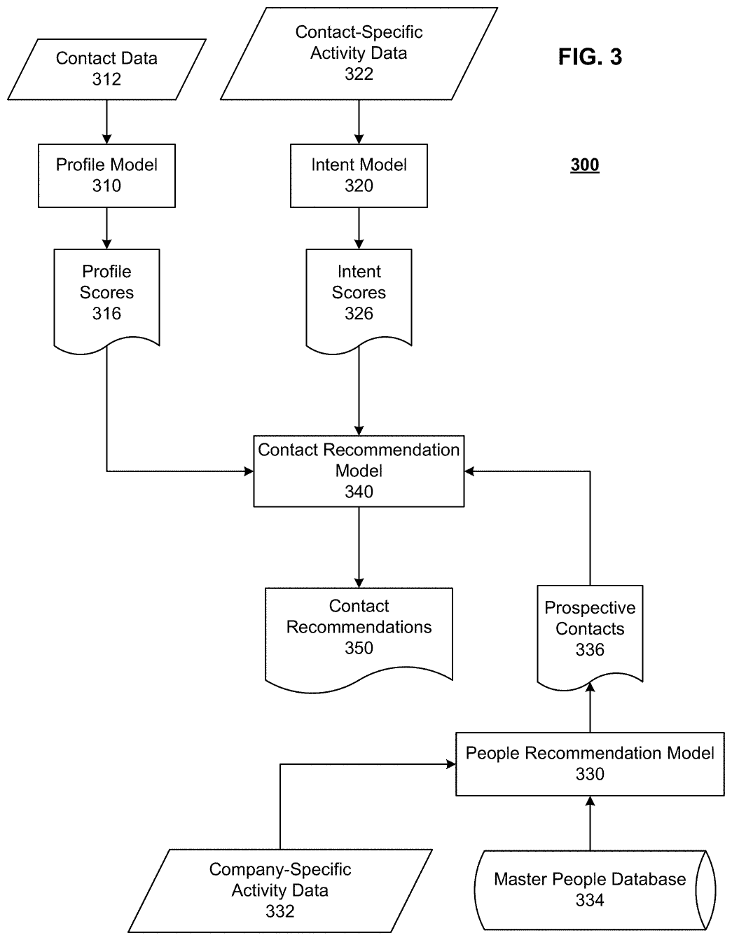

FIG. 3 illustrates an example of a contact recommendation engine 300, according to an embodiment. As illustrated, contact recommendation engine 300 may utilize a plurality of different models, including a profile model 310, an intent model 320, a people recommendation model 330, and/or a contact recommendation model 340. Profile model 310 may receive contact data 312 as input, and output profile scores 316 for each of the contacts represented in contact data 312. Intent model 320 may receive contact-specific activity data 322 as input, and output intent scores 326 for one or more contacts represented in contact-specific activity data 322. People recommendation model 330 may utilize company-specific activity data 332 and people records from a master people database 334 (e.g., maintained by an operator of platform 110), and output one or more prospective contacts 336. Contact recommendation model 340 may receive profile scores 316, intent scores 326, and/or prospective contacts 336, and output contact recommendations 350, representing next best actions in terms of outreach.

Profile model 310 may accept contact data 312 as an input, and determine a profile score 316 for each contact, in contact data 312, that represents the contact's level of “fit” for a particular sales opportunity or for any sales opportunity for a specific product. In other words, the profile score 316 for a contact indicates that contact's relevance to the opportunity or influence over the opportunity. Each profile score 316 may be a number within a range (e.g., 0 to 100), in which one end of the range represents no fit and the opposite end of the range represents a perfect fit. Contact data 312 may comprise, for each of a plurality of contacts, a contact identifier (e.g., name, or numeric, alphabetic, or alphanumeric identifier, etc.), contact information (e.g., email address, telephone number, etc.), the contact's job title, and/or the like. Contact data 312 may be imported from a customer's system, and the sales opportunity for which profile scores 316 are output may be a sale of a product sold by that customer.

In addition to the information in contact data 312, other information may be derived from contact data 312 and used by profile model 310. For example, the application may derive a job level and job function for each contact from the contact's job title and/or other information in contact data 312. For example, profile model 310 may utilize a job-title model that comprises a lookup table, machine-learning model, or the like that accepts an arbitrary job title as an input and outputs a job level and job function for that job title. For example, the job-title model may receive “director of marketing” as a job title, and output “director” as the job level and “marketing” as the job function.

In an embodiment, profile model 310 may utilize artificial intelligence, such as machine learning to derive profile scores 316 from contact data 312, including any information derived from contact data 312 (e.g., job level and job function). For example, profile model 310 may comprise a random forest algorithm or a gradient-boosting algorithm, such as XGBoost. A machine-learning profile model 310 may be trained on a training dataset drawn from a customer's sales and marketing databases, for example, within the customer's CRM and/or MAP systems (e.g., Salesforce™, Marketo™, etc.). The training dataset may associate features of contacts (e.g., job title, job level, and/or job function) with sales opportunities that were opened, won, and/or lost. For example, a training dataset that is extracted from a Salesforce™ system may associate an “opportunity” object with “opportunity contact role” objects, and each “opportunity contact role” object may associate a role with a contact's information (e.g., comprising the same or similar information as contact data 312). Each “opportunity contact role” object may specify the role that the associated contact had in the opportunity represented by the “opportunity” object. Similar training datasets can be extracted from other systems.

Profile model 310 can be trained, on the training dataset, to assign a profile score 316 to a contact, based on one or more features in contact data 312. These features may include, for example, each contact's job title, job level, and/or job function, and may be weighted by coefficients in a machine-learning algorithm. The target variable for training may be the likelihood of a positive outcome (i.e., an opened and/or won opportunity). In such an embodiment, profile scores 316 may represent the predicted likelihood of a positive outcome (i.e., as the fit). It should be understood that outcomes, in this context, are sales opportunities.

In an embodiment, a profile model 310 may be generated for each enterprise user or customer of platform 110. In other words, each customer is associated with a particular customer-specific profile model 310 that is trained on that customer's contact data 312. For example, a first profile model 310 may be generated from (e.g., trained on) a first customer's contact data 312 and only used to generate profile scores 316 for that first customer's contacts, whereas a second profile model 310 may be generated from (e.g., trained on) a second customer's contact data 312 and only used to generate profile scores 316 for that second customer's contacts. The first customer would not utilize the second profile model 310, and the second customer would not utilize the first profile model 310. In other words, the application associated specific profile models 310 with specific customer accounts.

Similarly, if a customer sells a plurality of products, a customer-specific profile model 310 may be generated for each product sold by the customer. In other words, each product sold by a given customer is associated with a particular product-specific profile model 310 that is trained on that customer's contact data 312 as it pertains to sales opportunities related to that product. For example, a first profile model 310 may be generated from (e.g., trained on) a customer's contact data 312 related to sales opportunities for a first product and only used to generate profile scores 316 for sales opportunities for the first product, whereas a second profile model 310 may be generated from (e.g., trained on) the customer's contact data 312 related to sales opportunities for a second product and only used to generate profile scores 316 for sales opportunities for the second product.

Thus, in an embodiment, the application stores a plurality of profile models 310 (e.g., in database 114). Each customer may be associated with one or more customer-specific profile models 310. In addition, the customer-specific profile models 310 for a particular customer may comprise a plurality of product-specific profile models 310.

Intent model 320 may accept contact-specific activity data 322 as an input, and determine an intent score 326 for each contact, represented in contact-specific activity data 322, that represents the contact's intent to engage in a sales opportunity. Similarly to profile score 316, each intent score 326 may be a number within a range (e.g., 0 to 100), in which one end of the range represents no intent and the opposite end of the range represents definite intent. Contact-specific activity data 322 may comprise, for each of a plurality of contacts (e.g., the same set of contacts in contact data 312), representations of online and/or offline activity associated with that contact. Online activities may comprise visits to a web site, submission of a web form, opening an email message, sending an email message, opening an electronic document (e.g., a whitepaper), and/or the like. Offline activities may comprise visiting a store, attending a trade show, answering a telephone call, initiating a telephone call, and/or the like. In general, contact-specific activity data 322 may comprise representations of interactions between the contacts and the customer that is supplying contact-specific activity data 322 (e.g., visiting the customer's website, logging into an online account with the customer, submitting a form to the customer, opening or sending an email to the customer, reading a whitepaper published by the customer, accepting or initiating a telephone call to the customer, visiting the customer's booth at a trade show, etc.). Contact-specific activity data 322 may be imported from the customer's system.

An embodiment of intent model 320 is disclosed in the '227 patent and the '056 patent. For example, different types of activities in contact-specific activity data 322 may be associated with different weights, indicating their relative predictiveness of a sales opportunity. For each contact, the contact-specific activity data 322 that are associated with that contact can be weighted according to an algorithm that considers the type and volume of a contact's activities to derive an intent score 326 for the contact. Intent model 320 may be a statistical model, comprising or based on a naïve Bayes algorithm. In such an embodiment, the likelihood of a contact being associated with an opened opportunity in the future may be calculated by combining the weights associated with the individual activities in that contact's timeline of activities in contact-specific activity data 322. One or more time-decay factors may be used to weight more recent activities greater than less recent activities.

As with profile model 310, a separate customer-specific intent model 320 may be generated and stored for each customer. In addition, for a given customer, a separate product-specific intent model 320 may be generated and stored for each product sold by the customer. It should be understood that intent model 320 for a first product and/or a first customer may differ from intent model 320 for a second product and/or second customer, because the set of relevant activities may differ (e.g., some website visits will be more relevant to the first product or customer than the second product or customer). In an alternative embodiment, the same intent model 320 may be used for every customer and/or every product sold by a given customer.

People recommendation model 330 may accept company-specific activity data 332 and records from a master people database 334 as inputs, and determine one or more, if any, prospective contacts 336 from master people database 334 that might be relevant to a customer. Notably, these prospective contacts may be unknown to a customer (e.g., not present in the customer's system or contact data 312). Accordingly, prospective contacts 336 may represent new opportunities for the customer. Thus, in an embodiment, the operator of platform 110 may require the customer to purchase prospective contacts 336 from the operator before being able to view, acquire, or otherwise access prospective contacts 336. The customer may purchase access to prospective contacts 336 as an ad hoc payment to purchase all prospective contacts 336 output by people recommendation model 330 at a given time, as an ad hoc payment for particular contacts in prospective contacts 336 output by people recommendation model 330 at a given time (e.g., on a per-contact basis based on non-identifying information provided by the operator about the contact), as a subscription payment for all prospective contacts 336 output by people recommendation model 330 within the subscription period provided by the subscription payment, and/or the like.

Company-specific activity data 332 may comprise representations of online and/or offline activity associated with companies and/or geographic locations (e.g., countries, states, cities, Zip codes, etc.). Company-specific activity data 332 may be similar or identical to contact-specific activity data 322, but are generally not associated with specific people or contacts. However, company-specific activity data 332 may be mapped (e.g., by people recommendation model 330 or some other function of the disclosed application that is upstream from people recommendation model 330) to specific companies via IP addresses, domain names, and/or cookies associated with online activities in company-specific activity data 332. An embodiment of such a mapping process is disclosed in the '427 patent. As an example, an IP address may be collected for each visit to a website. That IP address may be mapped to a particular company and geographic location (e.g., city), such that the visit to the website is mapped to the company and geographic location. Thus, while the particular person visiting the website may remain anonymous, the company and geographic location does not.

Master people database 334 may comprise a database of non-customer-specific contacts that are acquired by the operator of platform 110 directly (e.g., via data scraping, manual research, etc.) and/or indirectly from one or more third parties (e.g., data vendors). The operator may compile master people database 334 from a plurality of sources. Master people database 334 may comprise people data that are similar to contact data 312 (e.g., the same or similar fields as contact data 312). For example, master people database 334 may comprise, for each of a plurality of people, a name (e.g., first and last name), contact information (e.g., email address, telephone number, etc.), the company for which the person works, the location (e.g., company site) at which the person works (e.g., address, city, state, etc.), the person's job title, the person's job level, the person's job function, and/or the like.

Notably, intent model 320 cannot generally operate on people from master people database 334 to generate intent scores 326, since there is no person-specific activity data from which to derive intent scores 326. Thus, in an embodiment, people recommendation model 330 utilizes company-specific activity data 332 to derive company-level intent as a proxy for the intent of a particular person at that company. For example, people recommendation model 330 could generate company-level intent scores from company-specific activity data 332, similarly to how intent model 320 generates contact-level intent scores 326 from contact-specific activity data 322, to represent company-level intent. In other words, people recommendation model 330 may use a statistical model, comprising or based on a naïve Bayes algorithm. Each company-level intent score may represent the likelihood of a company being associated with a positive opportunity (e.g., opened and/or won) in the future. In an alternative embodiment, company-level intent may be derived and/or represented in a different manner. Regardless of how the company-level intent is derived and represented, the company-level intent (e.g., score) may represent the intent for a company and location (e.g., city and state), i.e., a company site. Thus, if a company has a plurality of sites (e.g., multiple offices), the company-level intent may be represented by a site-level intent score for each of the plurality of sites.

In an embodiment, the company-level intent that is derived for a particular company site is specific to the particular customer for which prospective contacts 336 are being output. For example, people recommendation model 330 may derive the company-level intent as it relates to a specific product being sold by the particular customer. In other words, people recommendation model 330 may derive the company-level intent from activities, represented in company-specific activity data 332, that are mapped to a particular customer and relevant to a specific product offered by that customer. Thus, to be even more specific, the company-level intent (e.g., score) may represent the intent by a specific company site to purchase a specific product sold by the customer.

Based on company-specific activity data 332, people recommendation model 330 may identify company sites with high intent levels (e.g., high intent scores, for example, above a threshold value) for a given customer's product, thereby indicating a high likelihood for a sales opportunity by that customer. People recommendation model 330 may retrieve people from master people database 334 that are associated with company sites that people recommendation model 330 has identified as having high intent levels. For example, people recommendation model 330 may identify records in master people database 334 that comprise the same company and location as each company site that has been identified as having a high intent level.

People recommendation model 330 may then assign a persona score to all of the people retrieved from master people database 334 for the companies with high intent levels. The persona scores may be similar to, and a proxy for, profile scores 316. For example, the persona score for a person may indicate the person's relevance to a sales opportunity or influence over the sales opportunity. Each persona score may be a number within a range (e.g., 0 to 100), in which one end of the range represents no fit and the opposite end of the range represents a perfect fit.

The persona score could, in fact, be a profile score 316. For example, a record for a person, retrieved from master people database 334, could be input into profile model 310 to produce a profile score 316 for the person, in the same manner that profile model 310 produces profile scores 316 from contact data 312. However, the records in master people database 334 will generally not have as much information as contact data 312. This is because contact data 312 may be acquired over time by a customer's direct interactions with a contact, whereas master people database 334 may be collected indirectly from data vendors, data scraping, and the like, which does not typically produce the same detailed level of information as direct interactions with a person. Thus, the persona score may be different from profile score 316.

In an embodiment, each record for a person in master people database 334 comprises at least a job title for the person, in addition to the person's name, contact information, company, and location. People recommendation model 330 may utilize the job title to determine a job level and job function. For example, people recommendation model 330 may utilize a job-title model, as discussed elsewhere herein, to derive the job level and job function from a given job title.

Regardless of how the job level and job function are determined, people recommendation model 330 may utilize the job level and job function to determine the persona scores using a persona model. For example, people recommendation model 330 may calculate the average profile score 316 for all contacts (e.g., from contact data 312) for the customer, for which prospective contacts 336 are being determined or across all customers for each job level and/or job function. For each person retrieved from master people database 334, people recommendation model 330 may determine a persona score for that person based on the average profile scores 316 for the contacts having a matching (e.g., same and/or similar) job level and/or job function. More generally, people recommendation model 330 may determine a persona score for each person as a function of that person's job title and/or job function and the profile scores 316 for contacts having the same or similar job title and/or job function.

People recommendation model 330 may rank the people, retrieved from master people database 334, according to their associated persona scores, to produce prospective contacts 336. Prospective contacts 336 may comprise only those people whose persona scores were greater than a predefined threshold value and/or only those people whose persona scores ranked them in a top subset (e.g., top three) of the ranked people. It should be understood that prospective contacts 336 represent the people, at companies that are likely to purchase the customer's product, who are likely to be the most influential over such a sale.

In an embodiment, people recommendation model 330 ensures that prospective contacts 336 are not already known contacts of the customer. For example, people recommendation model 330 may filter out or exclude, from prospective contacts 336, any people, retrieved from master people database 334, that are already known to the customer. People recommendation model 330 may identify people who are already known to the customer by matching the person's name (e.g., first and last names) and/or contact information (e.g., email address, telephone number, etc.) to names and/or contact information in contact data 312. Any matches indicate that the person is already known to the customer. Thus, people recommendation model 330 may exclude people that match the customer's contacts, from prospective contacts 336.

Contact recommendation model 340 may accept profile scores 316, intent scores 326, and/or prospective contacts 336 as inputs, and output contact recommendations 350 for a customer. Contact recommendations 350 may comprise two or more distinct sets of recommendations. For example, contact recommendations 350 may comprise a first set of recommendations that only includes known contacts of the customer (e.g., from contact data 312) and a second set of recommendations that only includes people that are unknown to the customer (e.g., prospective contacts 336).

The first set of recommendations of known contacts may be derived from profile scores 316 and/or intent scores 326. In an embodiment, the first set of recommendations of known contacts may be extracted from all contacts of the customer (e.g., in contact data 312) based on a ranked combination (e.g., weighted combination) of their profile scores 316 with their intent scores 326. For example, a composite score may be calculated for each contact from that contact's profile score 316 and intent score 326, the contacts may be ranked according to their composite score, and only a top subset (e.g., top three, five, ten, etc.) may be incorporated into contact recommendations 350. Alternatively, contacts may be ranked according to their respective profile scores 316, separately ranked according to their respective intent scores 326, and top subsets (e.g., top three, five, ten, etc.) from each of the rankings by profile scores 316 and intent scores 326 may be incorporated into contact recommendations 350.

As discussed elsewhere herein, the customer may be required to pay an ad hoc or subscription fee to obtain access to the second set of recommendations of unknown people (e.g., from prospective contacts 336). If the fee is paid, the full names and contact information for prospective contacts 336 may be incorporated into contact recommendations 350, and/or the information may be exported to the customer's system. Otherwise, if the fee is not paid, non-identifying information for each person in prospective contacts 336 may be incorporated into contact recommendations 350. This non-identifying information may include the name of the company for which the person works, a location (e.g., city and state) at which the person works, the person's job level and/or job function, and the like, but not the person's name and contact information. Thus, the customer can decide whether or not to pay the fee based on the quality of the leads. Once the customer pays the fee, the customer may then be enabled to access each person's name and contact information in prospective contacts 336.

In an embodiment, contact recommendation model 340 may exclude contacts whom have recently been contacted by the customer. For example, contact recommendation model 340 may search for recent interactions (e.g., within a predefined past time window from the current time) in contact data 312, and exclude any contacts with recent interactions from contact recommendations 350. Alternatively, contacts with recent interactions may be included in contact recommendations 350 but distinguished (e.g., highlighted, grayed out, annotated, etc.) from contacts without recent interactions.

In an embodiment, contact recommendations 350 comprise contacts and/or prospective contacts that satisfy one or more of a plurality of criteria. Each of the plurality of criteria represent different reasons for why the contacts and/or prospective contacts are likely to produce opportunities. For example, the first set of recommendations of known contacts may be selected based on one or more of the following criteria:
(1) Strong Profile: known contacts with high profile scores 316 (e.g., above a predefined threshold value and/or within a top number of profile scores 316) that have not been recently reached by sales representatives of the customer. The determination of whether or not a contact has been recently reached by a sales representative may be determined by searching interactions in contact data 312.
(2) High Intent: known contacts with high intent scores 326 (e.g., above a predefined threshold value and/or within a top number of intent scores 326) that have not been recently reached by sales representatives of the customer. The determination of whether or not a contact has been recently reached by a sales representative may be determined by searching interactions in contact data 312.
(3) Engaged, But Not Reached: known contacts that have been recently engaged with a marketing representative of the customer (e.g., within a past time window, such as four weeks, from the current time), but which have not been recently reached by sales representatives of the customer. The determination of whether or not a contact has been recently reached by a marketing representative and/or a sales representative may be determined by searching interactions in contact data 312.

Similarly, the second set of recommendations of unknown or prospective contacts 336 may be selected based one or more of the following criteria:
(4) Strong Profile: prospective contacts 336 with high persona scores (e.g., above a predefined threshold value and/or within a top number of persona scores).
(5) High Intent Site: prospective contacts 336 associated with a company site that has a high intent level (e.g., above a predefined threshold value and/or within a top number of intent scores).
(6) Strongest Profile at High Intent Site: prospective contacts 336 that have the highest persona scores at each company site that has a high intent level.

Contact recommendations 350 may be provided to a customer in a graphical user interface of the application and/or via an export of the data from platform 110 to a customer system (e.g., external system 140). In the case of an export, the data may be exported via an API of platform 110 and/or the customer system. Contact recommendations 350 may distinguish known contacts from prospective contacts 336. Contact recommendations 350 may also identify the criteria which each of the contacts and prospective contacts 336 satisfy. For instance, contact recommendations 350 could comprise a plurality of separate and distinct lists of contacts or prospective contacts 336, with each list representing a different one of the criteria. Alternatively, all of the known contacts may be provided in a single list, all of prospective contacts 336 may be provided in a single, separate list, or all of the known contacts and prospective contacts 336 could be provided in a single, composite list. As one example, the top three known contacts are selected by each of criteria (1)-(3) above and are merged into a single list (e.g., with de-duplication of redundant contacts that have been selected by multiple criteria), and the top three prospective contacts 336 are selected by each of criteria (4)-(6) above and are merged into a single list (e.g., with de-duplication of redundant prospective contacts 336 that have been selected by multiple criteria).

In summary, a contact recommendation engine 300 utilizes artificial intelligence (e.g., in profile model 310, intent model 320, people recommendation model 330, and/or contact recommendation model 340) to derive contact-related sales intelligence that can help a sales team of a customer increase engagement with a company account and drive sales opportunities. Contact recommendations 350 can be used as a stand-alone output from contact recommendation engine 300 or may be input into further functions of the sale intelligence application or a customer's system to drive one or more aspects of a larger B2B decision-making framework.

### 2.2. Talking Points

In an embodiment, the NBA function provides talking points to users (e.g., customers of platform 110). For instance, one or more talking points, at the account-level (e.g., general applicability) and/or contact-level (e.g., specific to a particular contact), may be derived from an analysis of data acquired from a customer and/or from other data sources. These talking point(s) may be provided to the customer to enable a sales representative of the customer to personalize a communication, such as a telephone call (e.g., cold call), email message, and/or the like. For example, the talking point(s) may be used when the user initiates an outreach to a particular contact. The talking points may be generated prior to or in response to the user's selection of a particular contact within the graphical user interface.

In an embodiment, the potential types of talking points that may be derived by the application for each customer include, without limitation, one or more of the following:
(1) Competitive Differentiation. The application may analyze company-specific activity data 332 to determine whether brand names (e.g., company names, product names, etc.) of competitors of the customer appear in company-specific activity data 332. For example, a company that intends to make a purchase in the future may utilize brand names to perform keyword searching, in order to evaluate various companies and/or products. The application may detect recent keyword searches (e.g., within a past time window, such as four weeks, from the current time), by one or more companies, for brand names that are relevant to the customer's business (e.g., brand names used by the customer's competitor(s)), in company-specific activity data 332. When the application detects these recent keyword searches for relevant brand names, the application may generate a talking point, based on the detected searches, to be provided to a user (e.g., a sales representative of the customer). The talking point may prompt the user to highlight the customer's competitive differentiation with respect to the specific brand names used in the detected searches. An example talking point may be:
“People at [company] have researched the following keywords in the past 4 weeks. If you call or email someone at [company], highlight your competitive differentiation with: [competitor A], [competitor B], . . . .”
(2) Awareness of Customer. The application may analyze company-specific activity data 332 to determine whether unbranded keyword searches that are relevant to the customer appear in company-specific activity data 332. For example, a company that intends to make a purchase in the future may utilize generic keywords when researching a type of product. This is indicative of the company not being informed about the customer's product. The application may detect recent keyword searches (e.g., within a past time window, such as four weeks, from the current time), by one or more companies, for unbranded terms that are relevant to the customer's business (e.g., terms that describe the customer's product(s)), in company-specific activity data 332. When the application detects these recent unbranded keyword searches, the application may generate a talking point, based on the detected searches, to be provided to a user (e.g., a sales representative of the customer). The talking point may prompt the user to contact the company based on the detected searches. An example talking point may be:
“[Company] has been investigating [relevant keywords] during the past 4 weeks, but appears to have not yet identified [customer] as a potential solution. You may want to proactively reach out to describe your product and its capabilities.”
(3) New Intent After Lost Opportunity. The application may identify contacts with high intent scores 326 that were involved in prior sales opportunities that may have been lost by the customer. This may indicate that the contact is once again seeking to purchase a product on behalf of the contact's company. When the application detects any such contacts, the application may generate a talking point to be provided to a user (e.g., a sales representative of the customer). The talking point may prompt the user to reach out to the contact(s). An example talking point may be:
“You lost an opportunity with [company] in the past 12 months, but they have now shown new intent in the past 4 weeks. [Contact] had an active role in the previous opportunity, so you may want to reach them to renew engagement.”
(4) High Intent Without Recent Outreach. The application may identify companies with high intent levels (e.g., from company-specific activity data 332) and no recent (e.g., within a past time window from the current time) attempts at outreach by a sales representative of the customer. The application may identify outreach attempts by analyzing contact data 312. When the application detects any such contacts, the application may generate a talking point to be provided to a user (e.g., a sales representative of the customer). The talking point may prompt the user to reach out to the contact(s) with the highest persona score for a given identified company. An example talking point may be:
“[Company] registers high intent but has not been recently reached by your sales team. We recommend reconnecting to [contact] with a personalized message based on their known activities.”
(5) Low Intent With High Recent Outreach. The application may identify companies with low intent levels for which a high number of recent attempts at outreach have been performed by sales representative(s) of the customer. This may indicate that the channel of communication being used for the outreach attempts is not working. The application may identify outreach attempts by analyzing contact data 312, and may determine companies' intent levels as discussed elsewhere herein using company-specific activity data 332 and/or intent scores 326. When the application detects any such companies, the application may generate a talking point to be provided to a user (e.g., a sales representative of the customer). The talking point may prompt the user to attempt outreach via one or more different channels of communication. For example, if all prior outreach attempts have been via one channel of communication, the talking point may prompt the user to try a different channel of communication. As examples, if prior outreach attempts were via marketing campaigns (e.g., emails from the customer's marketing team), the talking point may recommend initiating a direct telephone call; if prior outreach attempts were via telephone calls, the talking point may recommend sending an email message; if prior outreach attempts were by email message (e.g., from the customer's sales team), the talking point may recommend initiating a direct telephone call; if the prior outreach attempts only resulted in voicemails being left, the talking point may recommend sending an email message. An example talking point may be:
“Previous connections with [company] have been largely based on emails from your marketing team. Consider another approach, such as following up by call [contact] directly.”
(6) Executive Intent. The application may identify executive level contacts (e.g., C-suite or vice-president level) with high intent scores 326 (e.g., above a threshold value) and/or who have engaged with recent (e.g., within a past time window of the current time) sales or marketing activity from the customer. Following up with such contacts should be an immediate priority for the customer's sales representatives, so that the sales team can gauge where the company is in the buying process and what questions the contact may have about the customer's product. When the application detects any such contacts, the application may generate a talking point to be provided to a user (e.g., a sales representative of the customer). The talking point may prompt the user to reach out to the contact. An example talking point may be:
“[Contact], [job title], has opened and clicked through an email message sent by the marketing team. We recommend immediately following up with this contact to answer any questions they might have. Be ready to reference any executive relationships identified through your network and be prepared to talk about relevant customer case studies.”
(7) Contact Intent Update. Whenever a contact engages with recent (e.g., within a past time window of the current time) sales or marketing activities from the customer (e.g., as reflected by an increase in the contact's intent scores 326 (e.g., above a threshold value), the application may provide an update to a user via a talking point. The talking point may prompt the user to reach out to the contact. An example talking point may be:
“[Contact], [job title], has opened and clicked through an email message sent by the marketing team. We recommend that you follow up with this contact and renew engagement. You can see the full history of what the contact has done by clicking on the ‘view activities’ link.”

### 2.3. Presentation of Next Best Actions

In an embodiment, the sales intelligence application may generate a graphical user interface that provides access to a list of the next best actions that have been determined by the NBA feature described above. For example, a dashboard or other screen of the graphical user interface may comprise a tab or other link (e.g., hyperlink) to an NBA screen. The NBA screen may comprise a list of recommended actions. This list may be prioritized or ordered, such that recommended actions that should be performed before other actions are nearer to the top of the list than those other actions. However, the list may also be sortable by the user according to one or more parameters. The sales intelligence application may execute the NBA feature periodically to update the list periodically (e.g., daily). Advantageously, the list of recommended actions can be performed by one or more personnel of a business development team of a customer to convert one or more leads into successful sales opportunities.

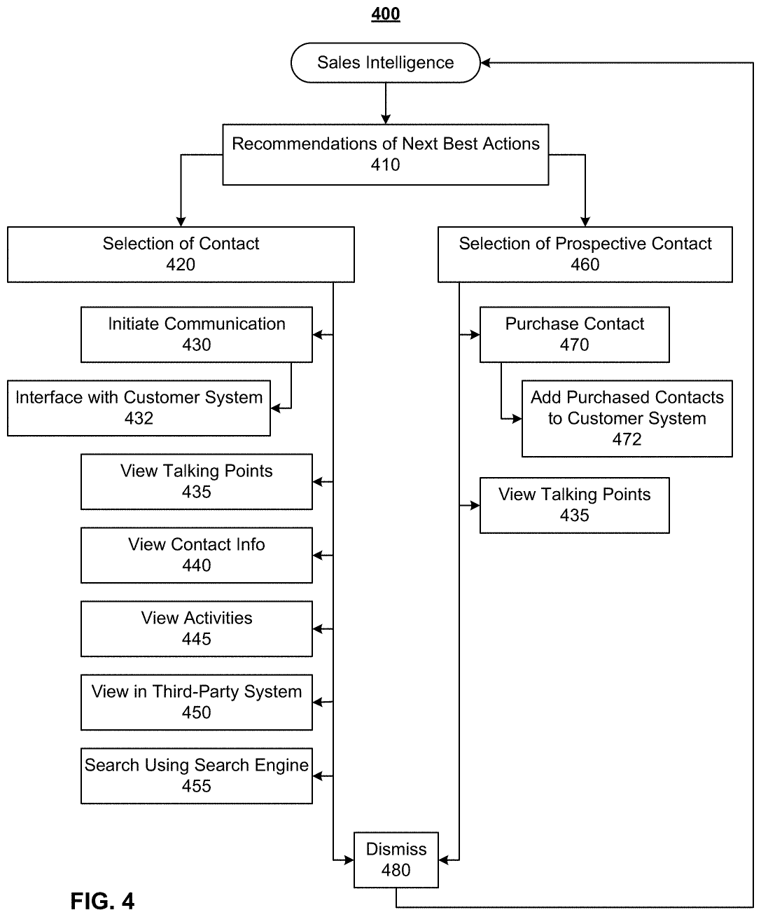

FIG. 4 illustrates an example flowchart of possible user interactions with the NBA feature (e.g., via a graphical user interface), according to an embodiment. As discussed elsewhere herein, the NBA feature may be a function of an overarching sales intelligence application, executed on platform 110 (e.g., as server application 112), with which a customer has an account. In an embodiment, recommendations 410 of next best actions is available via a link (e.g., an actions tab) in a primary screen (e.g., dashboard) of the graphical user interface of the customer's account. The actions tab may be an option that can be enabled or disabled via a settings screen of the customer's account.

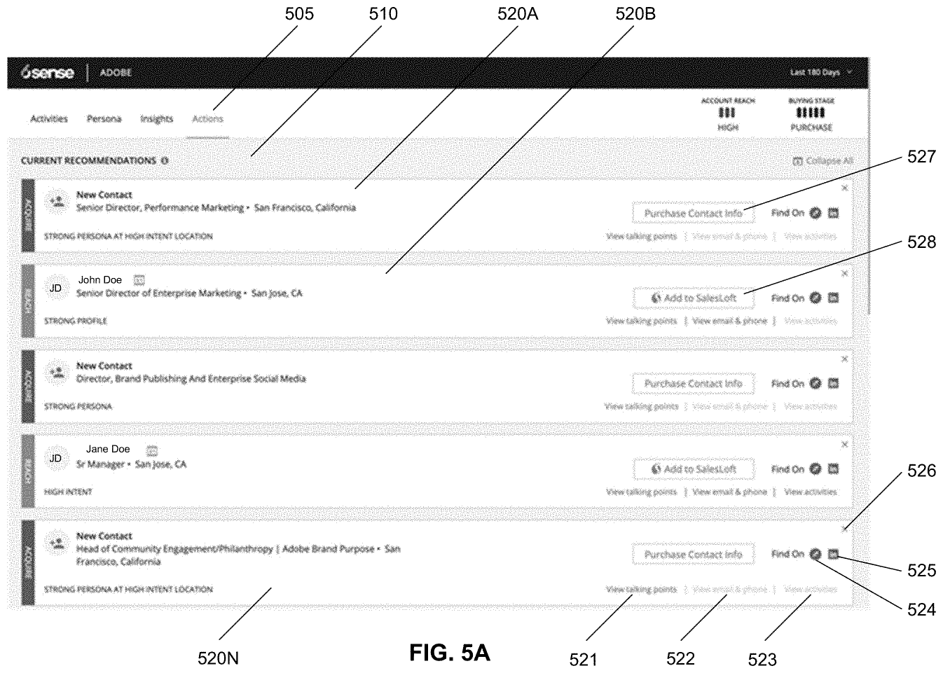

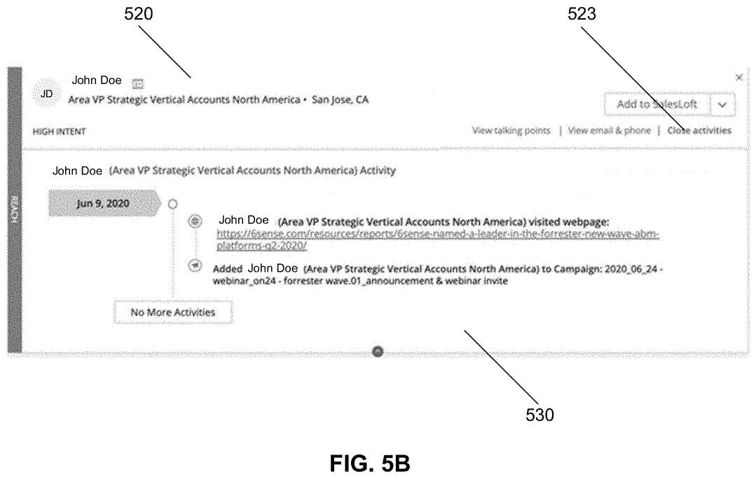

FIG. 5A illustrates an actions tab 505 of the graphical user interface, implementing recommendations 410, according to an embodiment. As illustrated, actions tab 505 comprises a recommended contact list 510, which comprise a plurality of contact entries 520. Each contact entry 520 represents either a known contact or a prospective contact from contact recommendations 350. For example, contact entry 520A is an example of a contact entry for a prospective contact, and contact entry 520B is an example of a contact entry for a known contact. It should be understood that each contact entry 520 represents a single contact at a relevant company. Known contacts are derived from contact data 312, and prospective contacts are derived from people recommendation model 330, as discussed elsewhere herein.

Each contact entry 520 may comprise information about the represented contact, such as an indication of whether the contact is known or prospective, job title, company, location (e.g., city and state), and/or one or more attributes of the contact. Contact entries 520 for known contacts may include the contact's name, whereas contact entries 520 for prospective contacts may not include the contact's name. For a known contact, the attribute(s) may comprise an indication of the contact's profile level (e.g., as defined by the contact's profile score 316) and/or intent level (e.g., as defined by the contact's intent score 326). For example, known contacts with high profile scores may be noted as “strong profile,” and known contacts with high intent scores may be flagged as “high intent.” For a prospective contact, the attribute(s) may comprise an indication of the contact's persona level (e.g., as defined by the contact's persona score) and/or company-specific intent level (e.g., as defined by the company-specific intent score). For example, prospective contacts with high persona scores may be noted as “strong persona,” and prospective contacts associated with companies having high intent levels may be noted as being at a “high intent location”. Each contact entry 520 may also comprise an input 521 for viewing recommended talking points for the represented contact, an input 522 for viewing contact information for the represented contact, an input 523 for viewing activities associated with the represented contact, an input 524 for viewing the represented contact in a third-party system (e.g., a sales engagement platform, such as Sales Navigator™), an input 525 for searching for the represented contact using a search engine (e.g., a search engine for a third-party professional networking platform, such as LinkedIn™), and/or an input 526 for deleting the contact entry 520 from recommended contact list 510. The talking points may be automatically generated by the application as discussed elsewhere herein. In addition, each contact entry 520 representing a prospective contact (e.g., contact entry 520A) may comprise an input 527 for purchasing the prospective contact, whereas each contact entry 520 representing a known contact (e.g., contact entry 520B) may comprise an input 528 for initiating an outreach to the known contact (e.g., by generating an outreach data structure in the customer's system, such as a sales “cadence” in SalesLoft™ or other sales engagement platform).

It should be understood that each input (e.g., 521-528) in each contact entry 520 may be implemented as hyperlink that redirects to a new screen of the graphical user interface and/or initiates a script to perform some action (e.g., expand/make visible or collapse/hide a frame of the respective contact entry 520) in the current screen of the graphical user interface. The set of inputs to be displayed may be a setting, such that a user can set specific inputs to be hidden. In addition, certain inputs may not be displayed or may be grayed out if they are not available for a specific contact or user. For example, in a contact entry 520A for an unpurchased prospective contact, input 522 for viewing contact information may be grayed out or hidden. For a contact with no activities, input 523 for viewing activities may be grayed out or hidden. If no third-party system or search engine has been configured in the application, inputs 524 and 525, respectively, may be grayed out or hidden.

A user of a customer's account may select a known contact 420 or prospective contact 460 from recommendations 410. For example, the user may select a known contact 420 represented by a contact entry 520B in recommended contact list 510 or may select a prospective contact 460 represented by a contact entry 520A in recommended contact list 510. In particular, the user may select one of a plurality of options available for each contact.

A different subset of the plurality of options may be available for a known contact 420 than for a prospective contact 460. In an embodiment, for a known contact 420, the user may initiate a communication 430, view talking points 435, view contact information 440, view activities 445, view the contact in a third-party system 450, search for the contact using a search engine 455, and/or dismiss the contact recommendation 480. For a prospective contact 460, the user may purchase the contact 470, view talking points 435, and/or dismiss the contact recommendation 480.

The user may initiate a communication 430 with a contact by selecting input 528 associated with that contact's contact entry 520. When the user selects input 528, the application may interface (e.g., via an API) with the customer's system (e.g., CRM or MAP system) to generate a communication or communication object through the customer's system. For example, if the customer's system (e.g., an external system 140) comprises SalesLoft™, the application may connect to the SalesLoft™ platform via the SalesLoft™ API to open a modal window, so that the user can select a Cadence to which to add the contact, and then close the modal window. In SalesLoft™, a Cadence is a data object that manages interactions with contacts by representing a repeatable sequence of steps that mimic the customer's sales process to create a more consistent sales process. The application may, via the SalesLoft™ API, authenticate with the customer's account on the SalesLoft™ platform using credentials (e.g., API key) provided by the user (e.g., specified in settings of the user's or customer's account with platform 110), and then generate a new Cadence object within the customer's SalesLoft™ account. A similar process may be performed for other sales engagement platforms.

The user may view talking points 435 for a contact by selecting input 521 associated with that contact's contact entry 520. When the user selects input 521 of a particular contact entry 520, the application may expand the contact entry 520 to display one or more talking points that have been generated for the contact, as discussed elsewhere herein. The talking point(s) may be generated beforehand (e.g., when contact recommendation model 340 generates contact recommendations 350) or in real or near-real time (e.g., after the user selects input 521 for the first time for a contact entry 520). After the application has expanded contact entry 520, the user may re-select input 521 to collapse the expanded contact entry 520 back to its original state.

The user may view contact information 440 for a contact by selecting input 522 associated with that contact's contact entry 520. When the user selects input 522 of a particular contact entry 520, the application may expand the contact entry 520 to display contact information for the contact represented by the contact entry 520. This contact information may comprise an email address, telephone number, mailing address, and/or the like of the contact. After the application has expanded contact entry 520, the user may re-select input 522 to collapse the expanded contact entry 520 back to its original state.

The user may view activities 445 for a contact by selecting input 523 associated with that contact's contact entry 520. When the user selects input 523 of a particular contact entry 520, the application may expand the contact entry 520 to display activities associated with the contact represented by the contact entry 520. FIG. 5B illustrates an example of a contact entry 520 after it has been expanded as a result of a user selecting input 523, according to an embodiment. As illustrated, the contact entry 520 is expanded vertically downward to comprise a timeline 530 of all activities (e.g., outreaches and engagements) associated with the contact, as well as their dates, from most recent to least recent. Notably, these activities may include activities from contact-specific activity data 322 (e.g., visits to the customer's website). After the application has expanded contact entry 520, the user may re-select input 523 to collapse the expanded contact entry 520 back to its original state.

The user may view a contact in a third-party system 450 (e.g., an external system 140) by selecting input 524 associated with that contact's contact entry 520. For example, the third-party system may be Sales Navigator™ by LinkedIn of Sunnyvale, Calif. Sales Navigator™ provides search capabilities within the LinkedIn™ professional networking platform, visibility into extended networks, and personalized algorithms to help customers reach an appropriate decision maker. When the user selects input 524 of a particular contact entry, the application may interface with the third-party system to retrieve information about the contact from the third-party system. For example, the application may, via an API of the third-party system, authenticate with the customer's account on the third-party system using credentials (e.g., API key) provided by the user (e.g., specified in settings of the user's or customer's account with platform 110), and then retrieve the contact's information. The application may generate a new frame or tab that displays the retrieved information within the graphical user interface.

The user may search for a contact using a search engine 455 (e.g., an external system 140) by selecting input 525 associated with that contact's contact entry 520. For example, the search engine may be LinkedIn™ by LinkedIn of Sunnyvale, Calif. When the user selects input 525 of a particular contact entry, the application may interface with the search engine to retrieve search results about the contact from the search engine. In particular, the application may, via an API of the search engine, submit a search query comprising the name of the contact, job title of the contact, location of the contact, and/or the like, and receive the results of a search performed by the search engine. The application may generate a new frame or tab that displays the received results within the graphical user interface.

The user may purchase a contact 470 by selecting input 527 associated with that contact's contact entry 520. When the user selects input 527, the application may interface (e.g., via an API) with the customer's system (e.g., CRM or MAP system) to generate a new contact object in the customer's system. In particular, the application may utilize the API of the customer's system to generate a data structure for the contact in whatever form the customer's system provides for representing contacts, and populate the contact's information in the generated data structure within the customer's system with information known to the application (e.g., in master people database 334). If the contact is successfully added to the customer's system, the application may display a success message (e.g., via a modal window). Otherwise, if an error occurs, the application may display an error message (e.g., via a modal window).

The user may dismiss a contact recommendation 480 by selecting input 526 associated with that contact's contact entry 520. In an embodiment, the user may dismiss the recommendation permanently or temporarily. For example, when the user selects input 526, the application may generate a frame (e.g., pop-up overlay) that comprises inputs for permanently dismissing the recommend contact, temporarily dismissing the recommended contact, and/or canceling the dismissal operation. The frame may also comprise an input for specifying how long to dismiss the recommended contact (e.g., in number of weeks) in the event that the user chooses to temporarily dismiss the recommended contact. If the user chooses to permanently dismiss the recommended contact, the recommended contact will not appear again as a contact entry 520 in recommended contact list 510. If the user chooses to temporarily dismiss the recommended contact, the recommended contact will not appear again as a contact entry 520 in recommended contact list 510 until a certain amount of time has passed (e.g., the specified amount of time in an embodiment in which an input is provided for specifying how long to dismiss the recommended contact). If the user chooses to cancel the dismissal operation, the application may close the frame without dismissing the recommended contact. In an embodiment, the application may maintain permanently and/or temporarily dismissed contacts in a history for the user (e.g., in a history tab available in the graphical user interface). Each dismissed contact in the history may be associated with an input for restoring the dismissed contact as a contact entry 520 in the recommended contact list 510.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to:
receive contact data from a user system, wherein the contact data comprise contact information for each of a plurality of contacts;
apply a profile model to the contact data to generate a profile score for each of the plurality of contacts;
receive contact-specific activity data from the user system, wherein the contact-specific activity data comprise activity information for each of the plurality of contacts;
apply an intent model to the contact-specific activity data to generate an intent score for each of the plurality of contacts;
determine one or more contact recommendations based on the profile scores and the intent scores for the plurality of contacts;
generate a recommended contact list comprising a contact entry for each of the one or more contact recommendations; and
provide the recommended contact list to at least one user.

2. The method of claim 1, wherein the profile model comprises a machine-learning algorithm that, for each of the plurality of contacts, predicts a likelihood of a positive sales opportunity based on one or more features of the contact.

3. The method of claim 2, wherein the one or more features comprise a job level and job function.

4. The method of claim 2, wherein the machine-learning algorithm is trained on a training dataset comprising the one or more features associated with one or both of positive sales opportunities and negative sales opportunities.

5. The method of claim 2, wherein the machine-learning algorithm comprises a random forest algorithm.

6. The method of claim 2, wherein the machine-learning algorithm comprises a gradient-boosting algorithm.

7. The method of claim 2, further comprising using the at least one hardware processor to retrieve the profile model from a plurality of profile models based on a customer account associated with the at least one user, wherein each of the plurality of profile models is associated with a different customer account.

8. The method of claim 1, wherein the intent model comprises a statistical model based on a naïve Bayes algorithm.

9. The method of claim 8, wherein, for each of the plurality of contacts, the activity information comprises representations of online activities associated with that contact, and wherein the statistical model weights the representations of online activities to generate the intent score for the contact.

10. The method of claim 9, wherein the online activities comprise one or more of a visit to a website, opening an electronic document, opening an email message, sending an email message, or submitting a web form.

11. The method of claim 9, wherein the statistical model comprises one or more time-decay factors to weight representations of more recent online activities greater than representations of less recent online activities.

12. The method of claim 1, further comprising using the at least one hardware processor to:
receive company-specific activity data from one or more data sources, wherein the company-specific activity data comprise activity information for each of a plurality of companies;
apply another intent model to the company-specific activity data to generate an intent score for each of the plurality of companies;
retrieve a plurality of people records from a master people database, wherein the plurality of people records comprise contact information for a plurality of people;
apply a persona model to the plurality of people records to generate a persona score for each of the plurality of people; and
determine one or more prospective contact recommendations based on the persona scores for the plurality of people, wherein the recommended contact list further comprises a contact entry for each of the one or more prospective contact recommendations.

13. The method of claim 12, wherein applying the persona model to the plurality of people records to generate a persona score for each of the plurality of people comprises, for each of the plurality of people records:
determining an average profile score for a subset of the plurality of contacts that have a job level and job function that matches a job level and job function derived from the people record; and
determining the persona score based on the average profile score.

14. The method of claim 12, wherein determining one or more prospective contact recommendations comprises excluding any of the plurality of people that are represented in the contact data.

15. The method of claim 12, wherein each contact entry for the one or more contact recommendations comprises identifying information, and wherein each contact entry for the one or more prospective contact recommendations does not comprise identifying information.

16. The method of claim 15, wherein providing the recommended contact list to at least one user comprises incorporating the recommended contact list into a graphical user interface, and wherein each contact entry for the one or more prospective contact recommendations comprises an input for acquiring the identifying information.

17. The method of claim 16, further comprising using the at least one hardware processor to, in response to selection of the input in a contact entry for one of the one or more prospective contact recommendations, interface with an external system via an application programming interface (API) of the external system to:
generate a contact object in the external system; and
populate the contact object in the external system with information from one of the plurality of people records corresponding to the contact entry for which the input was selected.

18. The method of claim 1, wherein determining one or more contact recommendations comprises excluding any of the plurality of contacts for which the contact data comprise a representation of an outreach within a predefined past time window from a current time.

19. The method of claim 1, further comprising using the at least one hardware processor to generate one or more talking points for each of one or more of the plurality of contacts.

20. The method of claim 19, wherein providing the recommended contact list to at least one user comprises incorporating the recommended contact list into a graphical user interface, and wherein each contact entry for each of the one or more contact recommendations comprises an input for viewing the one or more talking points.

21. The method of claim 19, wherein generating the one or more talking points comprises:
receiving company-specific activity data from one or more data sources, wherein the company-specific activity data comprise activity information for each of a plurality of companies;
identifying one or more keywords, representing one or more brand names, in the company-specific activity data; and,
based on the identification, generating a talking point that prompts the at least one user to highlight a competitive differentiation with respect to the one or more brand names.

22. The method of claim 19, wherein generating the one or more talking points comprises:
receiving company-specific activity data from one or more data sources, wherein the company-specific activity data comprise activity information for each of a plurality of companies;
identifying one or more keywords, associated with a product that is associated with a customer account of the at least one user but not associated with a brand name associated with the customer account, in the company-specific activity data associated with at least one of the plurality of companies; and,
based on the identification, generating a talking point that prompts the at least one user to contact the at least one company.

23. The method of claim 19, wherein generating the one or more talking points comprises:
identifying at least one of the plurality of contacts associated with an intent score above a predefined threshold and satisfying one or more other criteria; and,
based on the identification, generating a talking point that prompts the at least one user to contact the at least one contact.

24. The method of claim 1, wherein providing the recommended contact list to at least one user comprises incorporating the recommended contact list into a graphical user interface, wherein each contact entry for each of the one or more contact recommendations comprises an input for initiating a communication with a contact represented by that contact entry, and wherein the method further comprises using the at least one hardware processor to, in response to selection of the input in one of the contact entries by the at least one user, interface with an external system via an application programming interface (API) of the external system, to:
authenticate with the external system using an API key associated with a customer account associated with the at least one user; and
generate a communication object, associated with the contact represented by the one contact entry, in the external system.

25. The method of claim 1, wherein providing the recommended contact list to at least one user comprises incorporating the recommended contact list into a graphical user interface, wherein each contact entry for each of the one or more contact recommendations comprises an input for retrieving information, associated with a contact represented by that contact entry, from an external system, and wherein the method further comprises using the at least one hardware processor to, in response to selection of the input in one of the contact entries by the at least one user:
interface with the external system via an application programming interface (API) of the external system, to
authenticate with the external system using an API key associated with a customer account associated with the at least one user, and
acquire the information, associated with the contact represented by the one contact entry, from the external system; and
incorporate the acquired information into the graphical user interface.

26. A system comprising:
at least one hardware processor; and
one or more software modules that are configured to, when executed by the at least one hardware processor,
receive contact data from a user system, wherein the contact data comprise contact information for each of a plurality of contacts,
apply a profile model to the contact data to generate a profile score for each of the plurality of contacts,
receive contact-specific activity data from the user system, wherein the contact-specific activity data comprise activity information for each of the plurality of contacts,
apply an intent model to the contact-specific activity data to generate an intent score for each of the plurality of contacts,
determine one or more contact recommendations based on the profile scores and the intent scores for the plurality of contacts,
generate a recommended contact list comprising a contact entry for each of the one or more contact recommendations, and
provide the recommended contact list to at least one user.

27. A non-transitory computer-readable medium having instructions stored therein, wherein the instructions, when executed by a processor, cause the processor to:
receive contact data from a user system, wherein the contact data comprise contact information for each of a plurality of contacts;
apply a profile model to the contact data to generate a profile score for each of the plurality of contacts;
receive contact-specific activity data from the user system, wherein the contact-specific activity data comprise activity information for each of the plurality of contacts;
apply an intent model to the contact-specific activity data to generate an intent score for each of the plurality of contacts;
determine one or more contact recommendations based on the profile scores and the intent scores for the plurality of contacts;
generate a recommended contact list comprising a contact entry for each of the one or more contact recommendations; and
provide the recommended contact list to at least one user.
